(19) United States
(12) Patent Application Publication
(10) Pub. No.: US 2012/0319954 A1
(43) Pub. Date: Dec. 20, 2012

(54) MULTI-FUNCTIONAL WIRELESS MOUSE

(75) Inventor: JIA-HONG CHEN, Tu-Cheng (TW)

(73) Assignee: HON HAI PRECISION INDUSTRY CO., LTD., Tu-Cheng (TW)

(21) Appl. No.: 13/405,373

(22) Filed: Feb. 27, 2012

(30) Foreign Application Priority Data
Jun. 17, 2011 (TW) 100121147

(51) Int. Cl. G06F 3/033

(52) U.S. Cl. 345/163

(57) ABSTRACT

A multi-functional wireless mouse includes a mouse module, for implementing functions of a conventional mouse; a wireless transmission module, electronically connected with the mouse module, for wirelessly transmitting operational signals of the mouse module; a battery, electronically connected to the mouse module, for providing power to the mouse module; a charging module, electronically connected with the battery for charging the battery; a card reader, for reading data in a memory card; and a USB port connected to the charging module, to be connected to a computer via a USB line, for obtaining power from the computer to charge the battery via the USB line and the charging module, and transmitting data between the computer and the memory card via the USB line.

### BACKGROUND

1. Technical Field

The present invention relates to wireless mice, and more particularly to a multi-functional wireless mouse.

2. Description of Related Art

In general, a keyboard and a mouse are used as an apparatus for inputting information to a computer. Recently, due to the development of technology, a wireless mouse is widely used.

However, the function of the wireless mouse is single, more functions are needed.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views. isometric

FIG. 1 is an isometric view of an embodiment of a multi-functional wireless mouse in one view angle.

FIG. 2 is another isometric view of an embodiment of the multi-functional wireless mouse of FIG. 1 in another view angle.

FIG. 3 is a bottom view of an embodiment of the multi-functional wireless mouse of FIG. 1.

FIG. 4 is a block diagram of an embodiment of the multi-functional wireless mouse of FIG. 1.

FIG. 5 is an isometric view of an embodiment of the multi-functional wireless mouse and a seat charger of the multi-functional wireless mouse of FIG. 1.

### DETAILED DESCRIPTION

Embodiments of the present disclosure will be described with reference to the accompanying drawings.

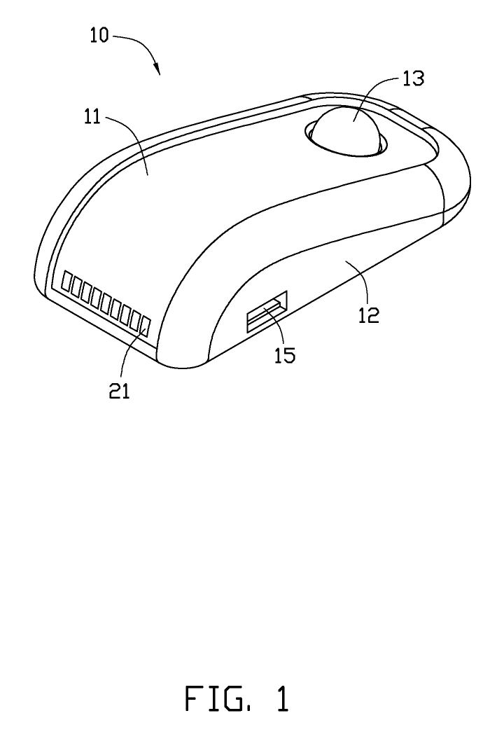

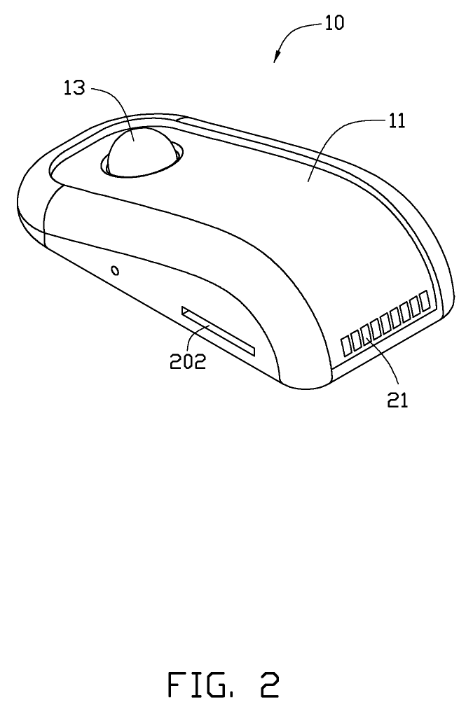

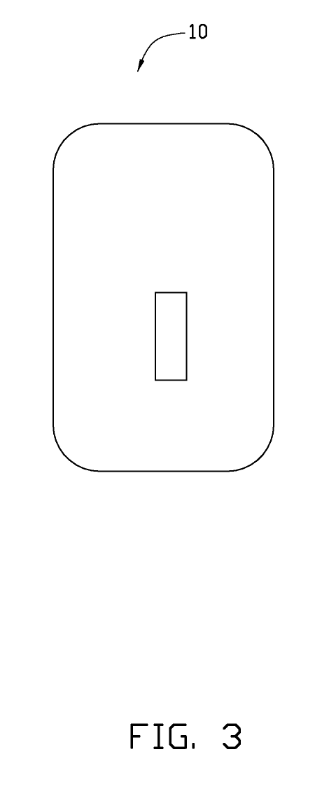

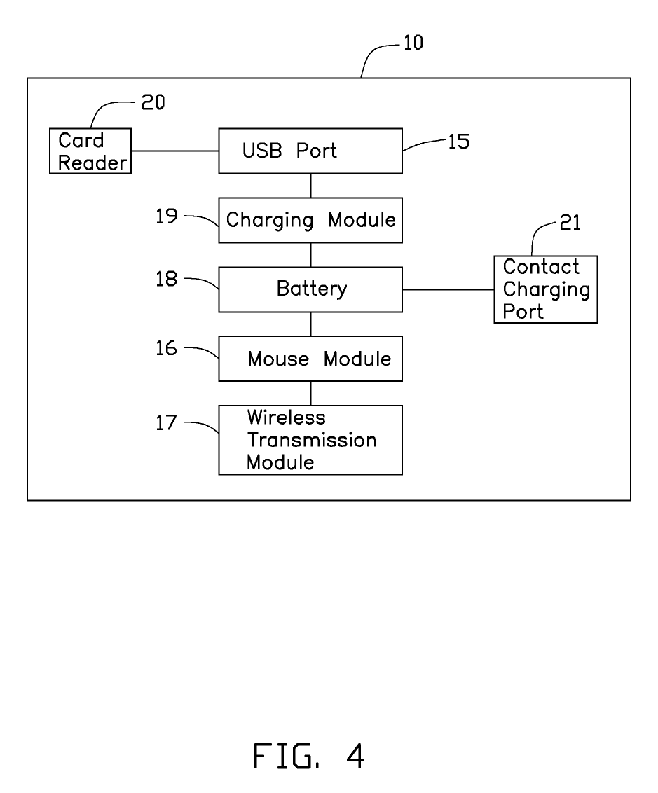

In FIGS. 1-4, a multi-functional wireless mouse 10 includes a top mouse body 11, a bottom mouse body 12 which is matching the top mouse body 11, a scrolling wheel 13, a USB port 15, a mouse module 16, a wireless transmission module 17, a battery 18, a charging module 19, a card reader 20, and a contact charging port 21. The card reader 20 has a card reader port 202 which matches a memory card. The card reader port 202 and the USB port 15 are respectively mounted on both sides of the bottom mouse body 12.

The mouse module 16 is used for implementing functions of a mouse such as operating a user interface, and includes known components such as can be found in a mechanical mouse or an optical mouse.

The wireless transmission module 17 is electronically connected of the mouse module 16 for wirelessly transmitting operational signals of the mouse module 16, for example, with the use of Bluetooth technology.

The battery 18 is electronically connected to the mouse module 16 for providing power to the mouse module 16. The battery 18 may be a rechargeable battery such as a lithium-ion battery.

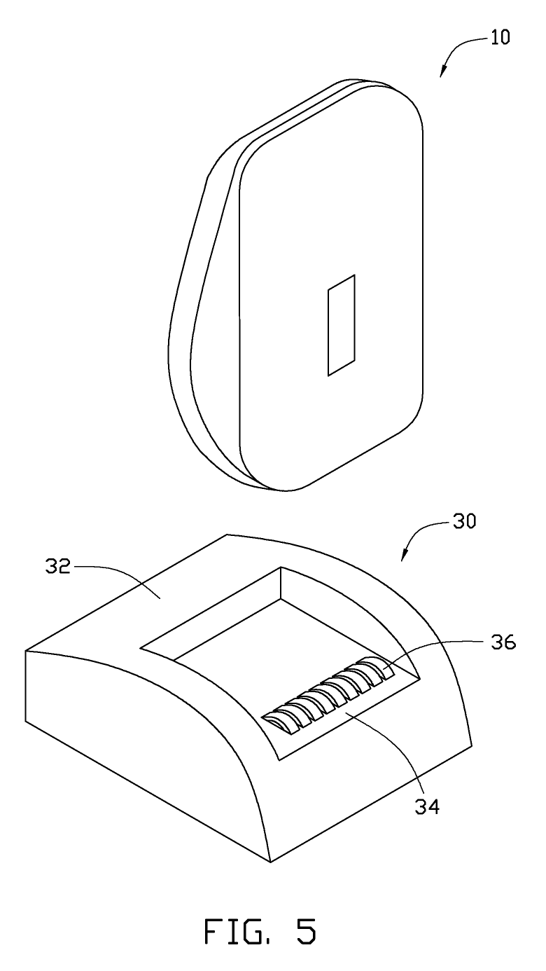

The contact charging port 21 is installed on one side of the multi-functional wireless mouse 10 which is far away from the scrolling wheel 13, and electronically connected to the battery 18. Also referring to FIG. 5, the contact charging port 21 matches a seat charger 30 for charging the battery 18. The seat charger 30 includes a bottom body 32 and a socket 34 mounted on the bottom body 32. Charge terminals are mounted in the socket 34 for matching the contact charging port 21.

The charging module 19 is electronically connected to the battery 18 for charging the battery 18. The charging module 19 is electronically connected to the USB port 15. The USB port 15 is connected to a computer via a USB line. The charging module 19 obtains power from the computer, and charges the battery 18 or transmits data between the computer and the memory card. The battery 18 can be charged via the USB port 15 and the charging module 19 of the computer or the contact charging port 21 of the seat charger 30.

The card reader 20 is configured to read data in the memory card. The memory card may be one or more of Smart Media (SM) card, Compact Flash (CF) card, Secure Digital Memory Card (SD) card, and Trans Flash (TF) card. In use, the memory card is inserted in the card reader port 202.

The multi-functional wireless mouse 10 of the present disclosure realizes the multi-functions of card reading and charging via the card reader port 202 and the contact charging port 21 and the USB port 15, which is advantageous over the single function of the wireless mouse.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A multi-functional wireless mouse comprising:
a mouse module, for implementing functions of a conventional mouse;
a wireless transmission module, electronically connected with the mouse module, for wirelessly transmitting operational signals of the mouse module;
a battery, electronically connected to the mouse module, for providing power to the mouse module;
a charging module, electronically connected with the battery for charging the battery;
a card reader, for reading data in a memory card; and
a USB port connected to the charging module, to be connected to a computer via a USB line, for obtaining power from the computer to charge the battery via the USB line and the charging module, and transmitting data between the computer and the memory card via the USB line.

2. The multi-functional wireless mouse of claim 1, wherein the multi-functional wireless mouse further comprises a contact charging port which matches a seat charger for charging the battery.

3. The multi-functional wireless mouse of claim 1, wherein the seat charger further comprises a bottom body, and a socket mounted on the bottom body, charge terminals are mounted in the socket for matching the contact charging port of the multi-functional wireless mouse.

4. The multi-functional wireless mouse of claim 2, wherein the contact charging port is installed on one side of the multi-functional wireless mouse which is far away from a scrolling wheel.

5. The multi-functional wireless mouse of claim 1, wherein the card reader port and the USB port are respectively mounted on both sides of a bottom mouse body of the multi-functional wireless mouse.

6. The multi-functional wireless mouse of claim 1, wherein the battery is rechargeable battery.

7. The multi-functional wireless mouse of claim 1, wherein the wireless transmission module uses Bluetooth technology.
